(19) United States
(12) Patent Application Publication
(10) Pub. No.: US 2023/0409356 A1
(43) Pub. Date: Dec. 21, 2023

(54) PASSWORD PROTECTION FOR SCREEN SHARING

(71) Applicant: Citrix Systems, Inc., Fort Lauderdale, FL (US)

(72) Inventors: Liang Zhou, Nanjing (CN); Taoyong Ding, Nanjing (CN); Hui Zhang, Nanjing (CN); Liang Dai, Nanjing (CN)

(21) Appl. No.: 17/811,351

(22) Filed: Jul. 8, 2022

Related U.S. Application Data
(63) Continuation of application No. PCT/CN2022/099704, filed on Jun. 20, 2022.

(51) Int. Cl. G06F 9/451; G06F 21/31

(52) U.S. Cl. CPC G06F 9/452; G06F 21/31

(57) ABSTRACT

In one aspect, an example methodology implementing the disclosed techniques may include, by a first computing device hosting an application that is being executed on a second computing device, detecting a start of a password input to the application, wherein the password input occurs during a session for sharing a screen of the second computing device. The method may also include, responsive to the detection, sending, by the first computing device to the second computing device, a notification to suspend the sharing of the screen of the second computing device. The application may be a virtual application. The second computing device may be a mobile device.

### CROSS REFERENCE TO RELATED APPLICATIONS

This application is a continuation of and claims the benefit of PCT Patent Application No. PCT/CN2022/099704 filed on Jun. 20, 2022 in the English language in the State Intellectual Property Office and designating the United States, the contents of which are hereby incorporated herein by reference in its entirety.

### BACKGROUND

Use of online or “virtual” meetings is becoming prevalent. For example, within a company, employees may participate in (e.g., attend) meetings, such as planning meetings, status meetings, etc., from different physical locations using various client devices. Online meeting services, such as TEAMS, SKYPE, ZOOM, GOTOMEETING, and WEBEX, may provide screen sharing services in addition to audio and video conferencing among other features. Using such services, a user can share digital content displayed on their computing device with one or more other users of remote computing devices.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

With the rise in work-from-home, hybrid, other flexible working arrangements, it is increasingly common for users to participate in online meetings from their homes, from shared offices, or even from cafes or other public spaces using their mobile devices. This can result in a loss of sensitive information when a user (a “presenter”) shares the contents displayed on their mobile device with other users (“audience members” or “the audience”) during an online meeting. For example, while screen sharing using a mobile device, the presenter may have occasion to enter (e.g., input) information into an application running on the mobile device. To enable the presenter to enter the information, the application on the mobile device may display a virtual or “onscreen” keyboard. This can result in a loss of sensitive information since the contents displayed on the mobile device is being shared, any information the presenter enters using the displayed keyboard will also be shared with audience. If the presenter enters sensitive information, such as a password, the sensitive information will be displayed and shared with the other users. Some operating systems on mobile devices are able to address the aforementioned sensitive information issue by detecting when a password is being input using the virtual keyboard and hiding (e.g., not display) the virtual keyboard so that the password is not shared with the audience. However, such operating systems are only able to detect password input to native applications running on the mobile device and unable to detect password input to non-native applications, such as virtual or web applications, running on the mobile device. Thus, when a presenter uses the virtual keyboard to enter a password into a non-native application, the operating system is unable to detect the password input and does not hide the virtual keyboard, resulting in the entered password being shared with the audience. Embodiments of the present disclosure can enhance, among other aspects, the privacy during online meetings by preventing sensitive information, such as passwords, entered by a presenter during screen sharing from being shared with the audience.

In accordance with one example embodiment provided to illustrate the broader concepts, systems, and techniques described herein, a method includes, by a first computing device hosting an application that is being executed on a second computing device, detecting a start of a password input to the application, wherein the password input occurs during a session for sharing a screen of the second computing device. The method also includes, responsive to the detection, sending, by the first computing device to the second computing device, a notification to suspend the sharing of the screen of the second computing device.

In some embodiments, the application is a virtual application.

In some embodiments, the second computing device is a mobile device.

In some embodiments, the password input to the application is via a virtual keyboard displayed on the screen of the second computing device.

In some embodiments, suspending the sharing of the screen includes sending, by the second computing device to a screen sharing service enabling the session, a request to suspend the sharing of the screen of the second computing device and, responsive to receiving the request, suspending, by the screen sharing service, the session. In one aspect, suspending the session includes sending, by the screen sharing service, a black screen to one or more remote computing devices participating in the session.

In some embodiments, the method also includes, responsive to a determination of a completion of the password input, sending, by the first computing device to the second computing device, a notification to resume the sharing of the screen of the second computing device.

In one aspect, resuming the sharing of the screen includes sending, by the second computing device to a screen sharing service enabling the session, a request to resume the sharing of the screen of the second computing device and, responsive to receiving the request, resuming, by the screen sharing service, the session.

In some embodiments, resuming the session includes ceasing, by the screen sharing service, sending of a black screen to one or more remote computing devices participating in the session.

According to another illustrative embodiment provided to illustrate the broader concepts described herein, a computing device includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a diagram of an illustrative network environment for password protection during screen sharing, in accordance with an embodiment of the present disclosure.

FIG. 6 is a diagram of a virtual keyboard displayed for entering information to an application on a computing device.

FIG. 7 is a block diagram of an illustrative system that provides password protection during screen sharing, in accordance with an embodiment of the present disclosure.

FIG. 8 is a sequence diagram showing an example flow of interactions between various components to provide password protection during screen sharing, in accordance with an embodiment of the present disclosure.

FIG. 9 is a diagram showing an example user interface (UI) that can be shared during a screen sharing session, in accordance with an embodiment of the present disclosure.

### DETAILED DESCRIPTION

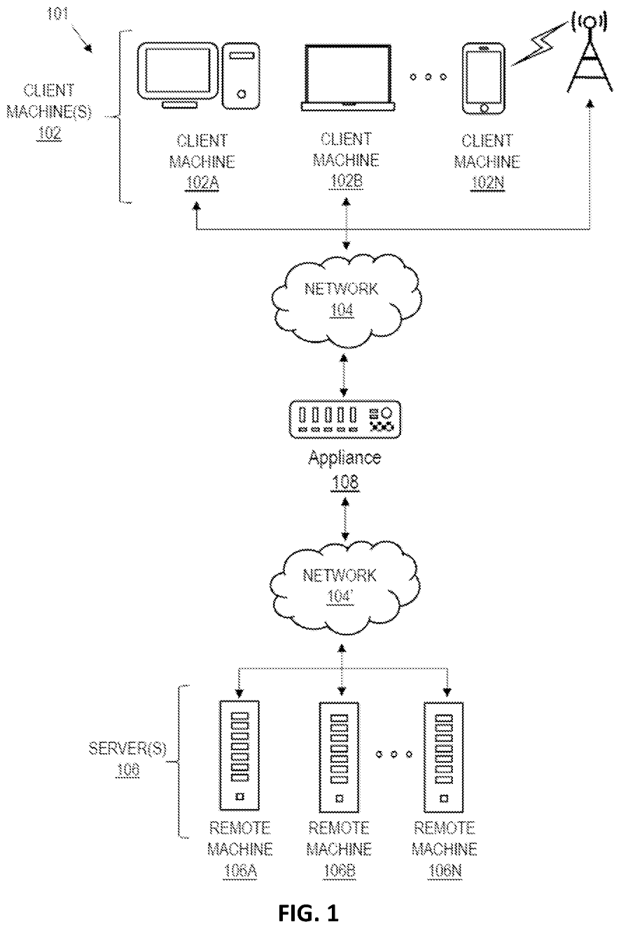

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

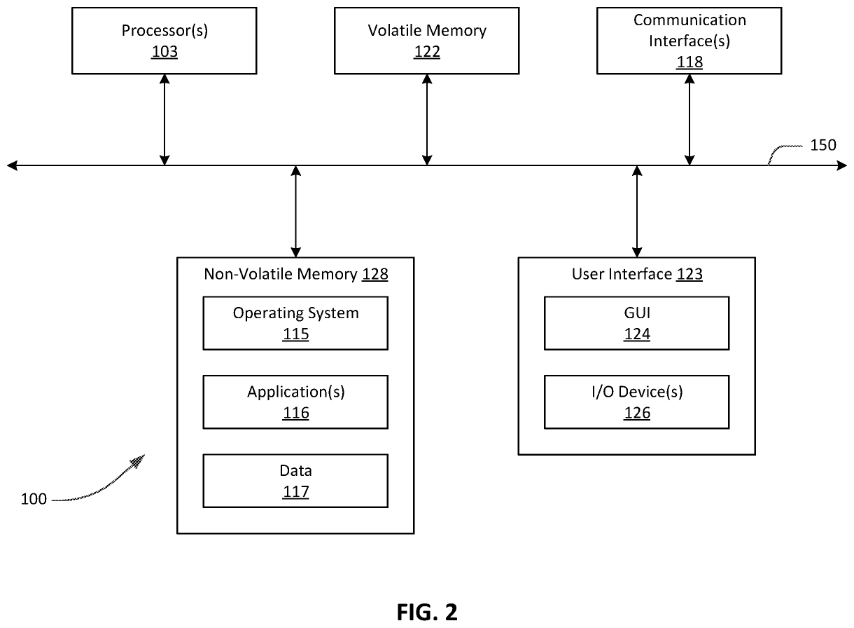

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (1/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

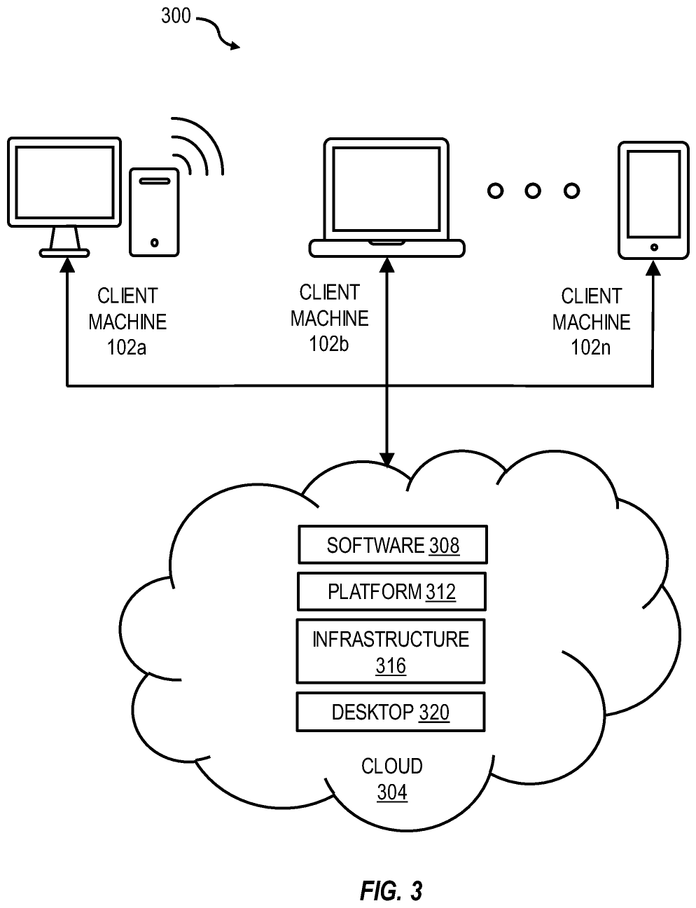

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

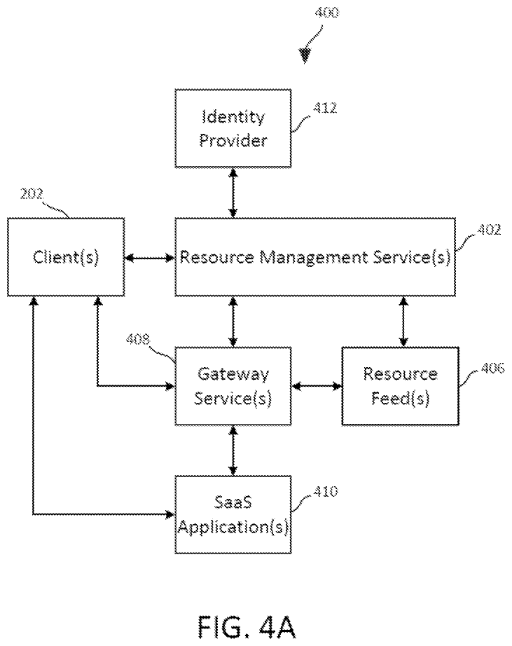

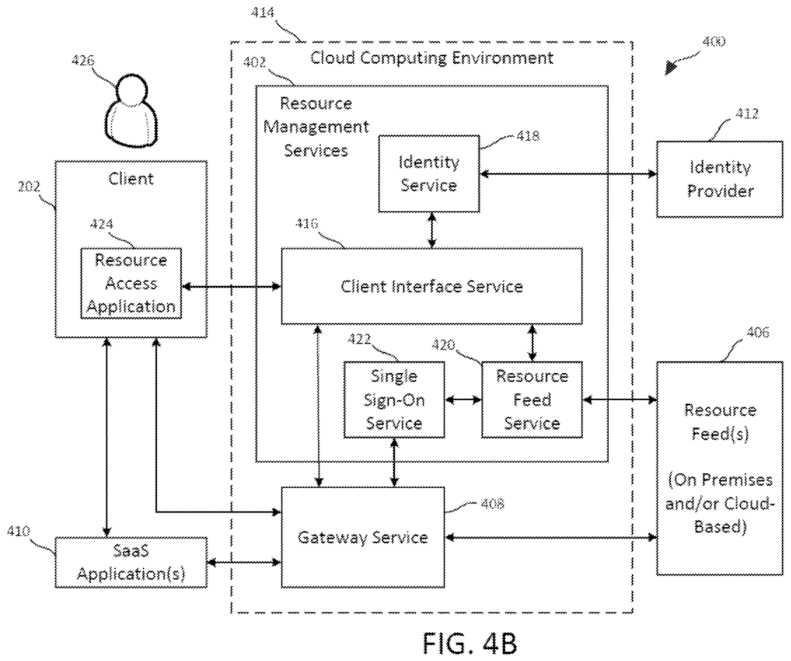

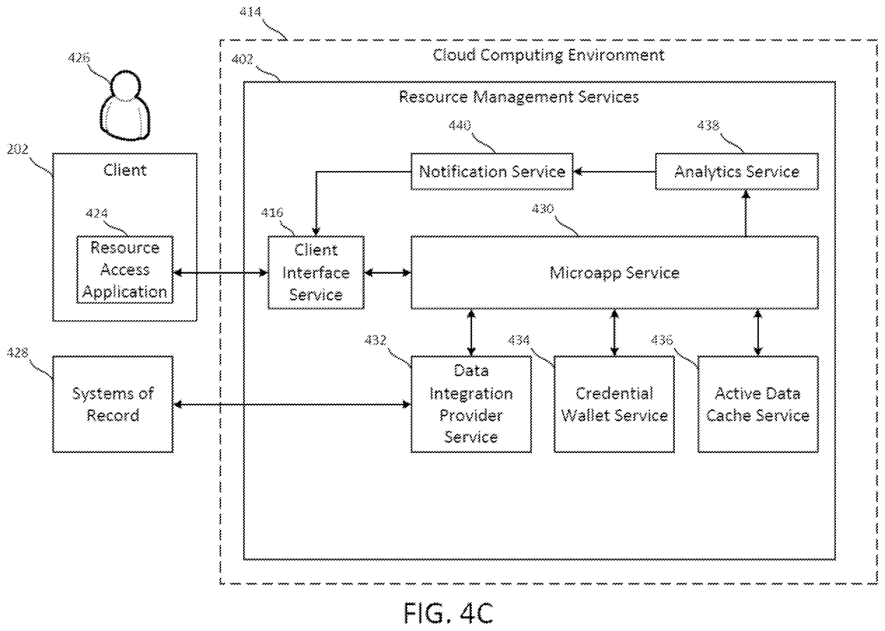

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

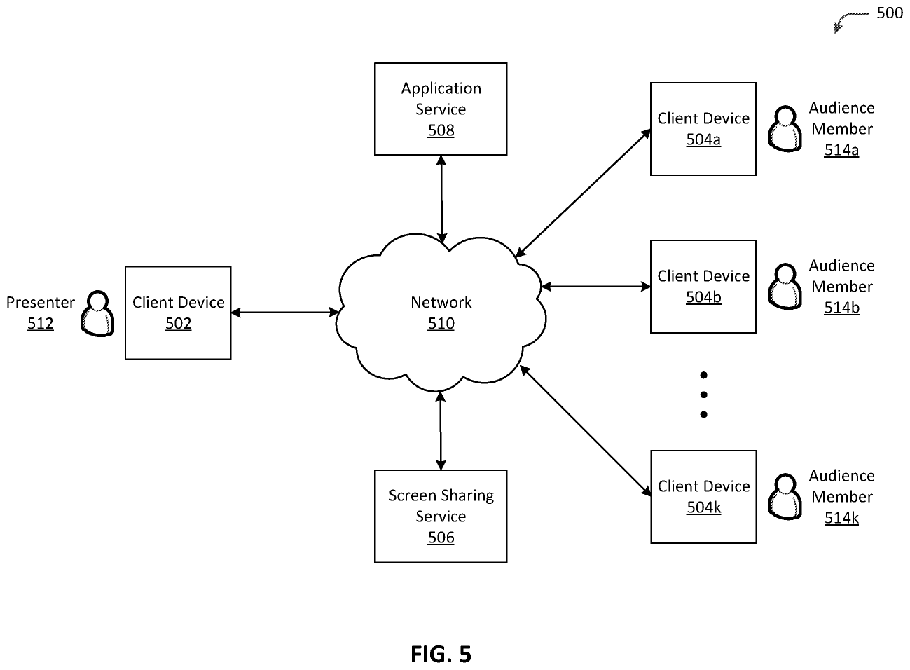

FIG. 5 is a diagram of an illustrative network environment 500 for password protection during screen sharing, in accordance with an embodiment of the present disclosure. As shown, illustrative network environment 500 includes a first client device 502, one or more second client devices 504a, 504b, . . . , 504k (504 generally), a screen sharing service 506, and an application service 508. Client device 502, client devices 504, screen sharing service 506, and application service 508 may be communicably coupled to one another via a network 510. Network 510 may correspond to one or more wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, and Near Field Communication (NFC) networks. In some embodiments, network 506 may include another network or a portion or portions of other networks. Screen sharing service 506 and/or application service 508 may be provided as part of a cloud computing environment (e.g., cloud computing environment 414 of FIGS. 4B-4C).

In the example of FIG. 5, a presenter 512 can use first client device (or “presenter client”) 502 to share their screen with one or more audience members 514a, 514b, . . . , 514k (514 generally) using respective second client devices (or “audience member clients”) 504a, 504b, . . . , 504k. Client devices 502, 504 can include, for example, desktop computing devices, laptop computing devices, tablet computing devices, and/or mobile computing devices. Client devices 502, 504 can be configured to run one or more applications, such as desktop applications, mobile applications, and SaaS applications. Among various other types of applications, client devices 502, 504 can run an application that provides screen sharing functionality (referred to generally as a “screen sharing application”). For example, client devices 502, 504 can run an online meeting application, such as TEAMS, SKYPE, ZOOM, GOTOMEETING, WEBEX, or another meeting application, that provides screen sharing. The screen sharing application running on client devices 502, 504 can communicate with screen sharing service 506 and/or with screen sharing applications running on other client devices 502, 504 (e.g., using P2P communication). In some embodiments, client device 502, 504 may be substantially similar to client machine 102 described above in the context of FIGS. 1 and 3, computing device 100 described above in the context of FIG. 2, and/or client 202 described above in the context of FIGS. 4A-4C.

Network environment 500 may provide services for one or more organizations, with the organizations having one or more users associated with it. A given client device (e.g., client device 502, 504) may be assigned to or otherwise associated with a particular user. For example, as shown in FIG. 5, client device 502 may be assigned to, or otherwise associated with, presenter 512 and client devices 504a, 504b, . . . , 504k may be assigned to, or otherwise associated with, audience members 514a, 514b, . . . , 514k, respectively.

Screen sharing service 506 may correspond to any service that enables presenter client device 502 to share its screen with audience member client devices 504. For example, screen sharing service 506 may correspond to an online meeting service such as TEAMS, SKYPE, ZOOM, GOTOMEETING, WEBEX, etc. In some embodiments, screen sharing service 506 may correspond to a SaaS application running in the cloud (e.g., within cloud network 304 of FIG. 3). In some embodiments, screen sharing service 506 may be omitted and screen sharing applications running on client devices 502, 504 may directly communicate with each other using P2P communication.

Presenter client device 502 can establish a screen sharing session with audience member client devices 504 via screen sharing service 506 (or, in some embodiments, directly using P2P). Presenter 512 can share an entire screen visible on client device 502 with audience members 514, meaning that any applications that are visible on the presenter's screen are also visible on audience member client devices 504. Alternatively, presenter 512 can share individual applications, or individual application windows, with audience members 514.

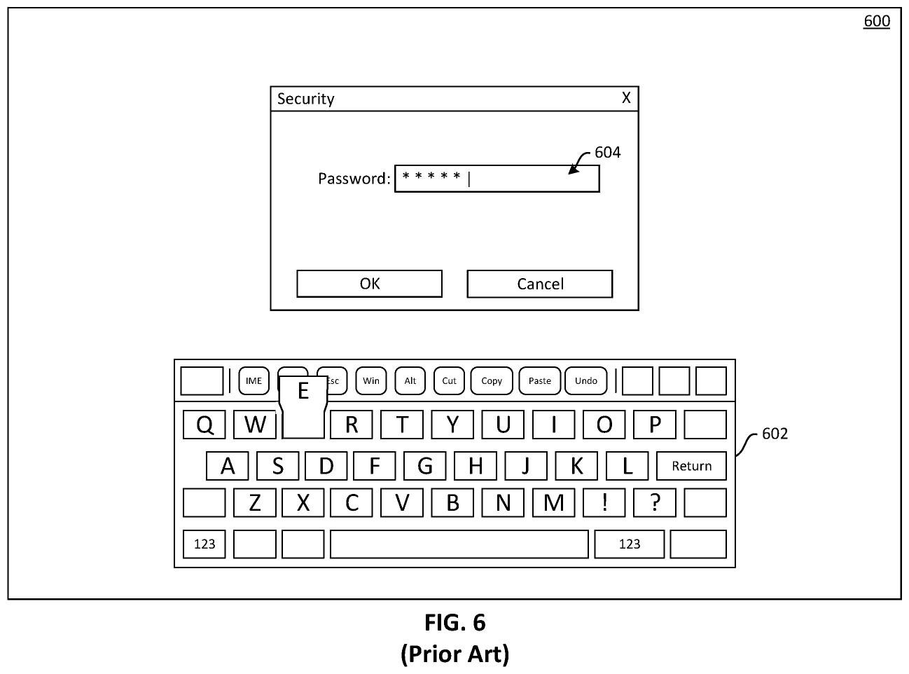

During the screen sharing session, presenter 512 may launch an application (e.g., a virtual application) provided by (e.g., hosted by) application service 508. Presenter 512 may enter a password to the application (e.g., enter a password into a UI element/control of the application that can receive keystrokes entered by the user). For example, as shown in FIG. 6 and with continued reference to FIG. 5, presenter 512 may use a virtual keyboard 602 displayed on a screen of client device 502 to enter a password into a text input field 604 of an application 600. During the screen sharing session, virtual keyboard 602 which is displayed on the screen of client device 502 is also displayed on the screens of client devices 504. Audience members 514 are able to view virtual keyboard 602 as well as the keys that are being selected/tapped on virtual keyboard 602 by presenter 512 to enter the password. For example, as shown in FIG. 6, audience members 514 may view the letter “E” that is being selected/tapped by presenter 512. As a result, the password being input using the displayed virtual keyboard 602 is shared with audience members 514.

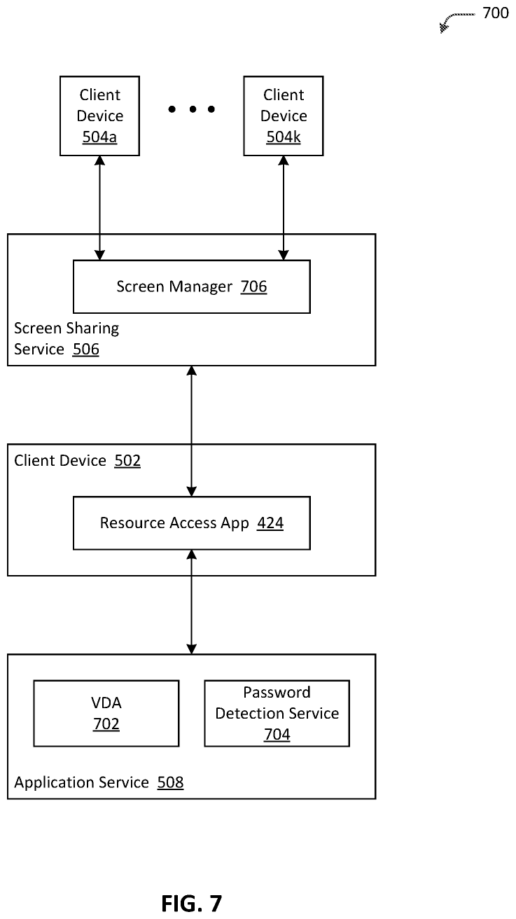

FIG. 7 is a block diagram of an illustrative system 700 that provides password protection during screen sharing, in accordance with an embodiment of the present disclosure. In FIG. 7, like elements of FIG. 5 are shown using like reference designators and, unless context dictates otherwise, may not be described again for purposes of clarity. Using the techniques and structures disclosed herein, screen sharing service 506 may automatically determine that a password is being entered to an application hosted thereby during a screen sharing session. In response to the determination, screen sharing service 506 may send a notification to suspend the screen sharing while the password is being entered to the application (e.g., notification to suspend the sharing of the presenter's screen for the duration of the password input to the application). As shown, illustrative system 700 includes presenter client device 502 and one or more audience member client devices 504 connected to screen sharing service 506, and presenter client device 502 connected to application service 508.

Client devices 502, 504 may be connected to screen sharing service 506 and client device 502 may be connected to application service 508 by one or more wired or wireless computer networks, such as network 510 of FIG. 5. In some embodiments, system 700 may form part of a network environment, such as network environment 500 of FIG. 5.

Application service 508 can include a (VDA) 702 and a password detection service 704. In embodiments, VDA 702 serves as an agent that allows application service 508 (e.g., the server(s) hosting application service 508) and the resources hosted by application service 508 to be made available to users. VDA 702 enables users to connect to the resources (e.g., applications) being hosted by application service 508. To this end, VDA 702 can be configured to provide various virtual desktop access services such as, by way of example, user access authentication and management, user session management, resource brokering and provisioning, and application of policies configured for the session.

In some embodiments, VDA 702 is configured to initiate password detection service 704 upon launching of sessions to access resources (e.g., applications) hosted by application service 508. For example, upon a user using resource access application 424 launching (e.g., establishing) a user session with VDA 702 to access a resource, VDA 702 may notify password detection service 704 of the launching of the user session by resource access application 424. The notification may include information about resource access application 424 used by the user to establish the user session and the resource being accessed via resource access application 424 (e.g., the resource being accessed during the user session).

In some embodiments, VDA 702 can determine a type of client device (e.g., mobile device or non-mobile device) that is being used by the user to interact with the resource. For example, VDA 702 may determine the type of client device that is being used from the user session information (e.g., the type of client agent executing on the client device or the keyboard settings established for the user session). VDA 702 can then send or otherwise provide information about the type of client device that is being used by the user (e.g., the type of client device associated with the user session to access the resource) to password detection service 704.

Password detection service 704 can monitor activity within a user session to access an application. That is, password detection service 704 can monitor activity within the application accessed by a user as the user interacts with the application. For example, password detection service 704 can monitor the inputs being made by the user to the application to detect a start of a password input. In response to a detection of a start of a password input to an application, password detection service 704 can notify resource access application 424 that is being used to access the application of the start of the password input to the application. Password detection service 704 can continue to monitor the inputs being made by the user to the application to detect an end of the password input (e.g., detect a completion of the password input). In response to a detection of a completion of the password input to the application, password detection service 704 can notify resource access application 424 that is being used to access the application of the completion of the password input to the application. In either case, the notification may indicate or otherwise identify the application to which the password is being input.

In one illustrative implementation, password detection service 704 may monitor message traffic in the operating system in which the application is running to detect the start and completion of a password input to the application. For example, password detection service 704 can hook into the operating system (e.g., generate an operating system API hook) to install a first process to monitor for and process a message indicative of a start of a password input (e.g., an EM_SETPASSWORDCHAR message in WINDOWS) before the message reaches the target operating system procedure (e.g., process a message indicative of a start of a password input prior to normal processing of such message by the operating system). In this example, the first process may generate and send a notification to resource access application 424 that is being used to access the application of a start of a password input to the application. In like manner, password detection service 704 can hook into the operating system to install a second process to monitor for and process a message indicative of a completion of a password input (e.g., a KEYCODE_ENTER or ACTION_DOWN KeyEvent in ANDROID) before the message reaches the target operating system procedure. In this example, the second process may generate and send a notification to resource access application 424 that is being used to access the application of a completion of a password input to the application.

In some embodiments, password detection service 704 may provide a notification of a start of a password input to resource access application 424 if the password input is via a virtual keyboard. For example, in response to a detection of a start of a password input to an application, password detection service 704 may determine whether the password is being input using a virtual keyboard displayed on a screen of the client device (e.g., a virtual keyboard displayed on a screen of a mobile device). In response to a determination that the password input is via a virtual keyboard displayed on the screen of the client device, password detection service 704 can notify resource access application 424 that is being used to access the application of the start of the password input to the application.

In response to receiving a notification of a start or a completion of a password input to an application, resource access application 424 can cause a suspension or a resumption of a session for sharing a screen of a client device on which resource access application 424 is executing (e.g., a suspension or a resumption of a screen sharing session that shares the application or an application window of the application). For example, in response to receiving a notification of a start of a password input to an application, resource access application 424 can send a request to screen sharing service 506 to suspend a sharing of a screen of a client device on which resource access application 424 is executing. Similarly, in response to receiving a notification of a completion of a password input to an application, resource access application 424 can send a request to screen sharing service 506 to resume a sharing of a screen of a client device on which resource access application 424 is executing. In either case, the request sent to screen sharing service 506 may indicate or otherwise identify the client device on which resource access application 424 is executing and/or the application associated with the password input.

Still referring to system 700, screen sharing service 506 can include a screen manager 706. Screen manager 706 is configured to suspend and resume screen sharing sessions established using screen sharing service 506. For example, in response to screen sharing service 506 receiving a request to suspend a sharing of a screen of a client device, screen manager 706 can determine or identify a screen sharing session associated with the client device and suspend the screen sharing session thereby suspending the sharing of the screen of the client device. In one embodiment, screen manager 706 can suspend the screen sharing session upon determining that the screen sharing session is currently (or “actively”) sharing the application or an application screen of the application to which the password input is being made. Similarly, in response to screen sharing service 506 receiving a request to resume a sharing of a screen of a client device, screen manager 706 can determine or identify a suspended screen sharing session associated with the client device and resume the suspended screen sharing session thereby resuming (e.g., continuing) the sharing of the screen of the client device.

In operation, presenter 512 can use presenter client 502 to join a meeting with audience members 514 using respective audience member clients 504 (e.g., audience members 514a, 514b, . . . , 514k using respective audience member clients 504a, 504b, . . . , 504k). While participating in the meeting, presenter 512 can establish a screen sharing session to share the screen of presenter client 502 with audience members 514. While sharing the screen of presenter client 502, presenter 512 can use resource access application 424 running on presenter client 512 to access a virtual application hosted by application service 508. For example, presenter 512 can click/tap a UI element/control in a UI of resource access application 424 to access the virtual application. Presenter 512 can start to input a password to the virtual application. Password detection service 704 of application service 508 can detect the start of the password input and send a notification to resource access application 424 of the detected password input. In response to such notification from password detection service 704, resource access application 424 can send a request to suspend the screen sharing session to screen sharing service 506. For example, the request may be to hide the screen of presenter client 502 so as to prevent the contents of the screen of presenter client 502 being displayed on audience member clients 504 and being viewed by audience members 514, for example. In response to such request from resource access application 424, screen manager 706 of screen sharing session 506 can suspend the screen sharing session.

When presenter 512 is finished (e.g., completes) inputting the password to the virtual application, password detection service 704 of application service 508 can detect the completion of the password input and send a notification to resource access application 424 of the detected completion of password input. In response to such notification from password detection service 704, resource access application 424 can send a request to resume the suspended screen sharing session to screen sharing service 506. In response to such request from resource access application 424, screen manager 706 of screen sharing session 506 can resume the suspended screen sharing session. For example, screen manager 706 may no longer hide the screen of presenter client 502 so as to allow the contents of the screen of presenter client 502 to be displayed on audience member clients 504 and be viewed by audience members 514, for example.

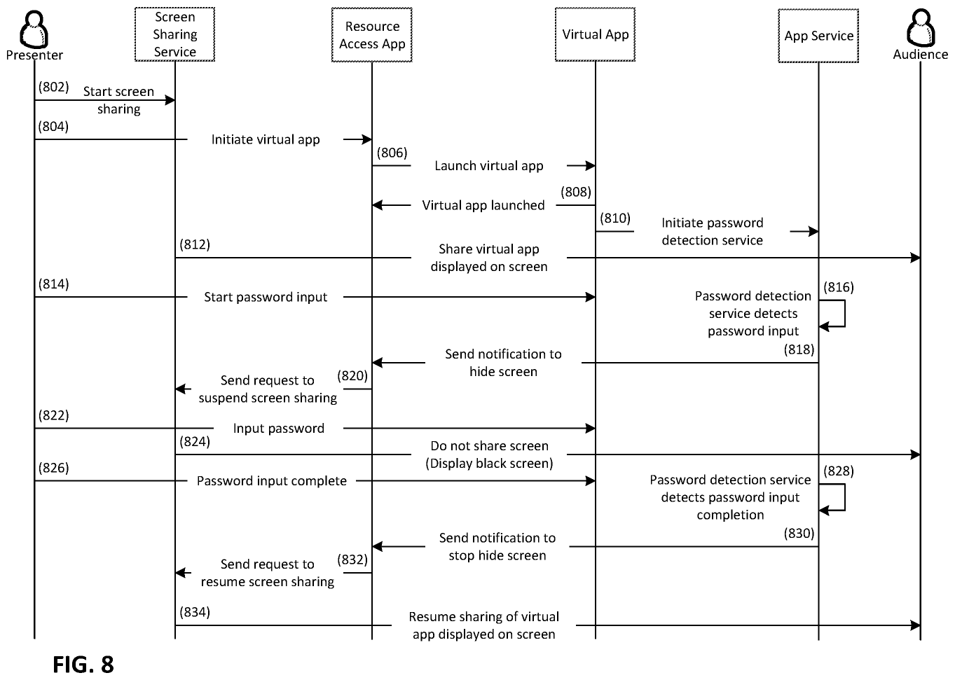

FIG. 8 is a sequence diagram showing an example flow of interactions between various components to provide password protection during screen sharing, in accordance with an embodiment of the present disclosure. For example, the interactions may be between various components of system 700 of FIG. 7 to protect passwords during a screen sharing session.

A presenter using a client device (e.g., client device 502 of FIG. 5) may start a screen sharing session (802) with a screen sharing service (e.g., screen sharing service 506 of FIG. 5) to share a screen of the presenter's client device with one or more audience members. The audience members may be using respective client devices (e.g., client devices 504 of FIG. 5). In some embodiments, the presenter's client device may be a mobile device. In some embodiments, the screen sharing session may be established by the presenter while participating in an online meeting with the audience members. In some such embodiments, the screen sharing service via which the screen sharing session is started may also be providing (e.g., hosting) the online meeting.

While sharing their screen, the presenter may use a resource access application on their client device to initiate an application (804) provided by an application service (e.g., application service 508 of FIG. 5). The application may be a virtual application hosted by the application service and accessible to the presenter. For example, the presenter may click/tap a link or other UI element displayed within a UI of the resource access application to initiate the virtual application.

In response to such input, the resource access application may launch the virtual application (806) initiated by the presenter. For example, to launch the virtual application, the resource access application may establish a user session with the application service providing the virtual application. Upon successful lauch of the virtual application, a notification of the successful launch of the virtual application (808) may be provided to the resource access application. Also, upon successfully launching an application hosted thereby (e.g., the virtual application initiated by the presenter), the application service may initiate a password detection service (e.g., password detection service 704 of FIG. 7) for the launched virtual application (810). Upon such initiation, the password detection service may monitor activity within the virtual application for input of a password (e.g., monitor to detect a start of a password input to the virtual application).

Upon success launch of the virtual application, the screen sharing service may share the virtual application displayed on the screen of the presenter's client device (812) with the audience member client devices. While the virtual application is being actively shared, the presenter may start to input a password (814) to the virtual application. For example, the presenter may use a virtual keyboard displayed on the screen of the client device whose screen is being shared to input the password to the virtual application.

When the presenter starts the password input to the virtual application, the password detection service initiated by the application service, and which is monitoring the activity within the virtual application, may detect the start of the password input (816) to the virtual application. Upon detecting the start of the password input, the password detection service may send a notification to the resource access application (818) of the detected start of the password input to the virtual application. For example, the notification may be to hide the screen of the presenter's client device which is being shared with the audience members.

In response to receiving the notification to hide the screen of the presenter's client device, the resource access application may send a request to the screen sharing service (820) to suspend the sharing of the screen of the presenter's client device. In response to receiving such request, the screen sharing service may suspend the sharing of the screen of the presenter's client device (e.g., suspend the screen sharing session established for sharing the screen of the presenter's client device).

During this time, the presenter may be using the virtual keyboard which is displayed on the screen of their client device to input the password (822) to the virtual application. However, the screen sharing service does not share the screen of the presenter's client device (824) since the sharing of the screen is suspended. Thus, the password that is being input to the virtual keyboard displayed on the screen of the presenter's client device is not shared with the audience member client devices. In some embodiments, while the sharing of the screen of the presenter's client device is suspended, the screen sharing service may send (e.g., share) a blank or black screen to the audience member client devices. In this way, the audience members are unable to view the password that is being input by the presenter since a blank or black screen is displayed on the screens of their client devices. In other words, the virtual keyboard displayed on the screen of the presenter's client device is not displayed on the screens of the audience member client devices.

The presenter may then complete the password input (826) to the virtual application. For example, the presenter may finish using the virtual keyboard to input the password. When the presenter completes inputting the password, the password detection service may detect the completion of the password input (828) to the virtual application. Upon detecting the completion of the password input, the password detection service may send a notification to the resource access application (830) of the detected completion of the password input to the virtual application. For example, the notification may be to stop hiding the screen of the presenter's client device which is being shared with the audience members.

In response to receiving the notification to stop hiding the screen of the presenter's client device, the resource access application may send a request to the screen sharing service (832) to resume the sharing of the screen of the presenter's client device. In response to receiving such request, the screen sharing service may resume the sharing of the screen of the presenter's client device (e.g., resume the suspended screen sharing session established for sharing the screen of the presenter's client device). The screen sharing service may resume the sharing of the screen of the presenter's client device (834) with the audience members. For example, the screen sharing service may resume sharing the virtual application displayed on the screen of the presenter's client device with the audience member client devices.

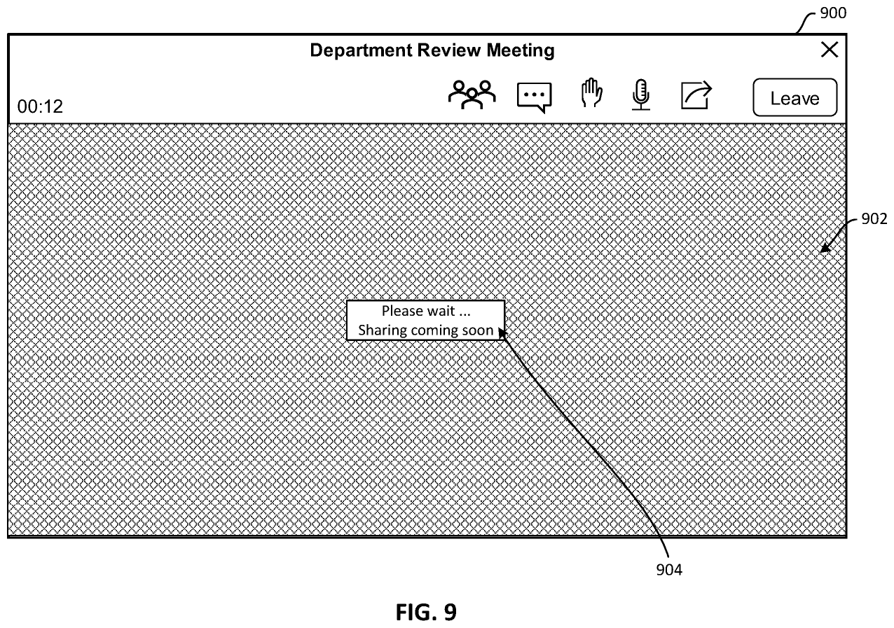

FIG. 9 is a diagram showing an example UI 900 that can be shared during a screen sharing session, in accordance with an embodiment of the present disclosure. UI 900 may be presented, for example, within a screen sharing application running on a client device, such as the screen sharing application running on client devices 504 of FIG. 5. More particularly, a screen sharing service (e.g., screen sharing service 506 of FIG. 5) may send a blank or black screen 902 (indicated by cross-hatching in FIG. 9) to audience member client devices for displaying within UI 900. For example, as described above, the screen sharing service may send screen 902 while sharing of a screen of a presenter's client device is suspended. The sharing of the screen may be suspended, for example, while a password is being input to an application (e.g., a virtual application) on the presenter's client device. As a result, while screen sharing is suspended, UI 900 displays screen 902 (indicated by cross-hatching) and not the contents displayed on the screen of the presenter's client device. By displaying screen 902 within UI 900, the password being input on the presenter's client device is not shared with the audience members and, thus, not leaked. As shown, in some embodiments, screen 902 can include a notice 904 informing the viewers (e.g., audience members) that sharing of the presenter's screen is currently suspended and that screen sharing will resume shortly.

### Further Example Embodiments

The following examples pertain to further embodiments, from which numerous permutations and configurations will be apparent.

Example 1 includes a method including: detecting, by a first computing device hosting an application that is being executed on a second computing device, a start of a password input to the application, wherein the password input occurs during a session for sharing a screen of the second computing device; and, responsive to the detection, sending, by the first computing device to the second computing device, a notification to suspend the sharing of the screen of the second computing device.

Example 2 includes the subject matter of Example 1, wherein the application is a virtual application.

Example 3 includes the subject matter of any of Examples 1 and 2, wherein the second computing device is a mobile device.

Example 4 includes the subject matter of any of Examples 1 through 3, wherein the password input to the application is via a virtual keyboard displayed on the screen of the second computing device.

Example 5 includes the subject matter of any of Examples 1 through 4, wherein suspending the sharing of the screen includes: sending, by the second computing device to a screen sharing service enabling the session, a request to suspend the sharing of the screen of the second computing device; and, responsive to receiving the request, suspending, by the screen sharing service, the session.

Example 6 includes the subject matter of Example 5, wherein suspending the session includes sending, by the screen sharing service, a black screen to one or more remote computing devices participating in the session.

Example 7 includes the subject matter of any of Examples 1 through 6, further including, responsive to a determination of a completion of the password input, sending, by the first computing device to the second computing device, a notification to resume the sharing of the screen of the second computing device.

Example 8 includes the subject matter of Example 7, wherein resuming the sharing of the screen includes: sending, by the second computing device to a screen sharing service enabling the session, a request to resume the sharing of the screen of the second computing device; and, responsive to receiving the request, resuming, by the screen sharing service, the session.

Example 9 includes the subject matter of Example 8, wherein resuming the session includes ceasing, by the screen sharing service, sending of a black screen to one or more remote computing devices participating in the session.

Example 10 includes a computing device including a processor and a non-volatile memory storing computer program code that when executed on the processor causes the processor to execute a process. The process includes: detecting a start of a password input to an application hosted by the computing device and being executed on a remote computing device, wherein the password input occurs during a session for sharing a screen of the remote computing device; and, responsive to the detection, sending to the remote computing device, a notification to suspend the sharing of the screen of the remote computing device.

Example 11 includes the subject matter of Example 10, wherein the application is a virtual application.

Example 12 includes the subject matter of any of Examples 10 and 11, wherein the remote computing device is a mobile device.

Example 13 includes the subject matter of any of Examples 10 through 12, wherein the password input to the application is via a virtual keyboard displayed on the screen of the remote computing device.

Example 14 includes the subject matter of any of Examples 10 through 13, wherein suspending the sharing of the screen includes: sending, by the remote computing device to a screen sharing service enabling the session, a request to suspend the sharing of the screen of the remote computing device; and, sending, by the remote computing device to a screen sharing service enabling the session, a request to suspend the sharing of the screen of the remote computing device.

Example 15 includes the subject matter of Example 14, wherein suspending the session includes sending, by the screen sharing service, a black screen to one or more remote computing devices participating in the session.

Example 16 includes the subject matter of any of Examples 10 through 15, wherein the process also includes, responsive to a determination of a completion of the password input, sending to the remote computing device, a notification to resume the sharing of the screen of the remote computing device.

Example 17 includes the subject matter of Example 16, wherein resuming the sharing of the screen includes: sending, by the remote computing device to a screen sharing service enabling the session, a request to resume the sharing of the screen of the remote computing device; and, responsive to receiving the request, resuming, by the screen sharing service, the session.

Example 18 includes the subject matter of Example 17, wherein resuming the session includes ceasing, by the screen sharing service, sending of a black screen to one or more remote computing devices participating in the session.

Example 19 includes a non-transitory machine-readable medium encoding instructions that when executed by one or more processors cause a process to be carried out. The process includes: detecting, by a computing device hosting an application that is being executed on a remote computing device, a start of a password input to the application, wherein the password input occurs during a session for sharing a screen of the remote computing device; and, responsive to the detection, sending, by the computing device to the remote computing device, a notification to suspend the sharing of the screen of the remote computing device.

Example 20 includes the subject matter of Example 19, wherein the application is a virtual application.

Example 21 includes the subject matter of any of Examples 19 and 20, wherein the second computing device is a mobile device.

Example 22 includes the subject matter of any of Examples 19 through 21, wherein the password input to the application is via a virtual keyboard displayed on the screen of the second computing device.

Example 23 includes the subject matter of any of Examples 19 through 22, wherein suspending the sharing of the screen includes: sending, by the remote computing device to a screen sharing service enabling the session, a request to suspend the sharing of the screen of the remote computing device; and, responsive to receiving the request, suspending, by the screen sharing service, the session.

Example 24 includes the subject matter of Example 23, wherein suspending the session includes sending, by the screen sharing service, a black screen to one or more remote computing devices participating in the session.

Example 25 includes the subject matter of any of Examples 19 through 24, wherein the process also includes, responsive to a determination of a completion of the password input, sending to the remote computing device, a notification to resume the sharing of the screen of the remote computing device.

Example 26 includes the subject matter of Example 25, wherein resuming the sharing of the screen includes: sending, by the remote computing device to a screen sharing service enabling the session, a request to resume the sharing of the screen of the remote computing device; and, responsive to receiving the request, resuming, by the screen sharing service, the session.

Example 27 includes the subject matter of Example 26, wherein resuming the session includes ceasing, by the screen sharing service, sending of a black screen to one or more remote computing devices participating in the session.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
detecting, by a first computing device hosting an application that is being executed on a second computing device, a start of a password input to the application, wherein the password input occurs during a session for sharing a screen of the second computing device; and
responsive to the detection, sending, by the first computing device to the second computing device, a notification to suspend the sharing of the screen of the second computing device.

2. The method of claim 1, wherein the application is a virtual application.

3. The method of claim 1, wherein the second computing device is a mobile device.

4. The method of claim 1, wherein the password input to the application is via a virtual keyboard displayed on the screen of the second computing device.

5. The method of claim 1, wherein suspending the sharing of the screen includes:
sending, by the second computing device to a screen sharing service enabling the session, a request to suspend the sharing of the screen of the second computing device; and
responsive to receiving the request, suspending, by the screen sharing service, the session.

6. The method of claim 5, wherein suspending the session includes sending, by the screen sharing service, a black screen to one or more remote computing devices participating in the session.

7. The method of claim 1, further comprising, responsive to a determination of a completion of the password input, sending, by the first computing device to the second computing device, a notification to resume the sharing of the screen of the second computing device.

8. The method of claim 7, wherein resuming the sharing of the screen includes:
sending, by the second computing device to a screen sharing service enabling the session, a request to resume the sharing of the screen of the second computing device; and
responsive to receiving the request, resuming, by the screen sharing service, the session.

9. The method of claim 8, wherein resuming the session includes ceasing, by the screen sharing service, sending of a black screen to one or more remote computing devices participating in the session.

10. A computing device comprising:
a processor; and
a non-volatile memory storing computer program code that when executed on the processor causes the processor to execute a process including:
detecting a start of a password input to an application hosted by the computing device and being executed on a remote computing device, wherein the password input occurs during a session for sharing a screen of the remote computing device; and
responsive to the detection, sending to the remote computing device, a notification to suspend the sharing of the screen of the remote computing device.

11. The computing device of claim 10, wherein the application is a virtual application.

12. The computing device of claim 10, wherein the remote computing device is a mobile device.

13. The computing device of claim 10, wherein the password input to the application is via a virtual keyboard displayed on the screen of the remote computing device.

14. The computing device of claim 10, wherein suspending the sharing of the screen includes:
sending, by the remote computing device to a screen sharing service enabling the session, a request to suspend the sharing of the screen of the remote computing device; and
responsive to receiving the request, suspending, by the screen sharing service, the session.

15. The computing device of claim 14, wherein suspending the session includes sending, by the screen sharing service, a black screen to one or more remote computing devices participating in the session.

16. The computing device of claim 10, wherein the process also includes, responsive to a determination of a completion of the password input, sending to the remote computing device, a notification to resume the sharing of the screen of the remote computing device.

17. The computing device of claim 16, wherein resuming the sharing of the screen includes:
sending, by the remote computing device to a screen sharing service enabling the session, a request to resume the sharing of the screen of the remote computing device; and
responsive to receiving the request, resuming, by the screen sharing service, the session.

18. The computing device of claim 17, wherein resuming the session includes ceasing, by the screen sharing service, sending of a black screen to one or more remote computing devices participating in the session.

19. A non-transitory machine-readable medium encoding instructions that when executed by one or more processors cause a process to be carried out, the process including:
detecting, by a computing device hosting an application that is being executed on a remote computing device, a start of a password input to the application, wherein the password input occurs during a session for sharing a screen of the remote computing device; and
responsive to the detection, sending, by the computing device to the remote computing device, a notification to suspend the sharing of the screen of the remote computing device.

20. The machine-readable medium of claim 19, wherein suspending the sharing of the screen includes:
sending, by the remote computing device to a screen sharing service enabling the session, a request to suspend the sharing of the screen of the remote computing device; and
responsive to receiving the request, suspending, by the screen sharing service, the session.
